(19) United States
(12) Patent Application Publication
(10) Pub. No.: US 2025/0283558 A1
(43) Pub. Date: Sep. 11, 2025

(54) TRIPLE-WALLED CONDUIT, AIRCRAFT COMPRISING AT LEAST ONE SUCH TRIPLE-WALLED CONDUIT

(71) Applicant: Airbus Operations SAS, TOULOUSE (FR)

(72) Inventors: Yannick CAZABONNE, TOULOUSE (FR); Gilles CHAULET, TOULOUSE (FR)

(21) Appl. No.: 19/070,109

(22) Filed: Mar. 4, 2025

(30) Foreign Application Priority Data
Mar. 6, 2024 (FR) FR2402245

(51) Int. Cl. F16L 9/18; F16L 39/00

(52) U.S. Cl. CPC F16L 9/18; F16L 39/00

(57) ABSTRACT

A triple-walled conduit comprising a main section that has internal, intermediate and external tubes extended by internal, intermediate and external endpieces, respectively, at least one connector that has a through-hole and first and second joining tubes, which surround the through-hole and face at least one surface of the internal, intermediate and external endpieces, at least one first sealing system interposed between the internal endpiece and one of the joining tubes of the connector, at least one second sealing system interposed between the intermediate endpiece and one of the joining tubes of the connector, at least one third sealing system interposed between the external endpiece and one of the joining tubes of the connector.

### CROSS-REFERENCES TO RELATED APPLICATIONS

This application claims the benefit of French Patent Application Number FR2402245 filed on Mar. 6, 2024, the entire disclosure of which is incorporated herein by way of reference.

### FIELD OF THE INVENTION

The present application relates to a triple-walled conduit and to an aircraft comprising at least one such triple-walled conduit.

### BACKGROUND OF THE INVENTION

According to one embodiment, a hydrogen-powered aircraft comprises at least one hydrogen tank and hydrogen pipelines connecting the hydrogen tank to hydrogen turbojets or to fuel cells powering electric motors.

These hydrogen pipelines must be configured to convey hydrogen in liquid form, at a temperature of around −270° C., and be perfectly sealed in order to avoid any contact between hydrogen and oxygen.

According to one embodiment, hydrogen is conveyed through double-walled conduits each comprising an external tube and an internal tube positioned within the external tube, a first connector to which the internal and external tubes are rigidly connected, a second connector that has a joining tube interposed between the internal and external tubes and seals interposed between the joining tube and the internal and external tubes in order to provide sealing between the joining tube and the internal and external tubes. Thus, the second connector is not connected to the internal and external tubes by a rigid connection, but by a connection that allows slight rotational movements along three axes and a movement in translation between the second connector and the internal and external tubes. This connection makes it possible to compensate for any deformation and/or expansion phenomena between the first and second connectors.

### SUMMARY OF THE INVENTION

The present invention aims to enhance the sealing of a double-walled conduit.

To this end, one subject of the invention is a triple-walled conduit comprising:
a main section that has:
an internal tube extended by at least one first internal endpiece having inner and outer surfaces,
an intermediate tube extended by at least one first intermediate endpiece having inner and outer surfaces,
an external tube extended by at least one first external endpiece having inner and outer surfaces,
at least one connector that has a through-hole and first and second joining tubes, which surround the through-hole and are positioned one inside the other, each of the first and second joining tubes having a portion that faces at least one inner or outer surface of the first internal, intermediate and external endpieces of the main section,
at least one first sealing system interposed between the inner or outer surface of the first internal endpiece and one of the first and second joining tubes of the connector,
at least one second sealing system interposed between the inner or outer surface of the first intermediate endpiece and one of the first and second joining tubes of the connector,
at least one third sealing system interposed between the inner or outer surface of the first external endpiece and one of the first and second joining tubes of the connector.

According to the invention, a triple-walled conduit comprises three sealing systems in series between the inside of the internal tube and the outside of the external tube, thereby contributing to enhancing the safety compared to a double-walled conduit.

According to another feature, the first joining tube is positioned inside the first internal endpiece or the second joining tube is positioned outside the first external endpiece.

According to another feature, the first joining tube is positioned inside the first internal endpiece and the second joining tube is positioned between the first intermediate and external endpieces.

According to another feature, the main section comprises first and second internal endpieces extending the internal tube on either side, first and second intermediate endpieces extending the intermediate tube on either side, and first and second external endpieces extending the external tube on either side. In addition, the triple-walled conduit comprises a first connector interacting with the first internal, intermediate and external endpieces of the main section and a second connector interacting with the second internal, intermediate and external endpieces of the main section.

According to another feature, the main section comprises at least two joining walls connecting the internal, intermediate and external tubes and/or the internal, intermediate and external endpieces in pairs.

According to another feature, the main conduit comprises at least one first joining wall, which connects the intermediate and external endpieces and has an inner edge connected to the intermediate endpiece and an outer edge connected to the external endpiece, and at least one second joining wall, which connects the internal and intermediate endpieces and has an inner edge connected to the internal endpiece and an outer edge connected to the intermediate endpiece.

According to another feature, the main section comprises second and third joining walls, which connect the internal and intermediate endpieces and are spaced apart from one another.

According to another feature, each sealing system comprises two peripheral grooves that are spaced apart so as to delimit an annular groove between them and an O-ring, which is at least partially housed in the annular groove and compressed between the main section and the connector. According to another feature, the two peripheral grooves are integral with a joining tube of a connector.

According to another feature, each peripheral groove comprises a frustoconical or curved peripheral face, the diameter of the peripheral face decreasing or increasing in a direction away from the annular groove in order to allow angular displacement between the main section and the connector.

Another subject of the invention is an aircraft having at least one triple-walled conduit according to one of the preceding features.

### BRIEF DESCRIPTION OF THE DRAWINGS

Other features and advantages will become apparent from the following description of the invention, the description being given solely by way of example, with reference to the appended drawings, in which:

FIG. 1 is a longitudinal section through a triple-walled conduit, illustrating one embodiment of the invention,

FIG. 2 is a longitudinal section illustrating in detail the region ZII of FIG. 1,

FIG. 3 is a perspective view of the triple-walled conduit shown in FIG. 1 in the disassembled state,

FIG. 4 is a longitudinal section through a main section of the triple-walled conduit shown in FIG. 1,

FIG. 5 is a perspective view of the main section shown in FIG. 4 from a first end,

FIG. 6 is a perspective view of the main section shown in FIG. 4 from a second end,

FIG. 7 is a longitudinal section through a portion of the main section shown in FIG. 4 after a first assembly step,

FIG. 8 is a longitudinal section through a portion of the main section shown in FIG. 4 after a second assembly step,

FIG. 9 is a longitudinal section through a portion of the main section shown in FIG. 4 after a third assembly step,

FIG. 10 is a longitudinal section through a portion of the main section shown in FIG. 4 after a fourth assembly step,

FIG. 11 is a longitudinal section through a portion of the main section shown in FIG. 4 after a fifth assembly step,

FIG. 12 is a longitudinal section through the main section shown in FIG. 4 after a sixth assembly step.

### DETAILED DESCRIPTION OF THE PREFERRED EMBODIMENTS

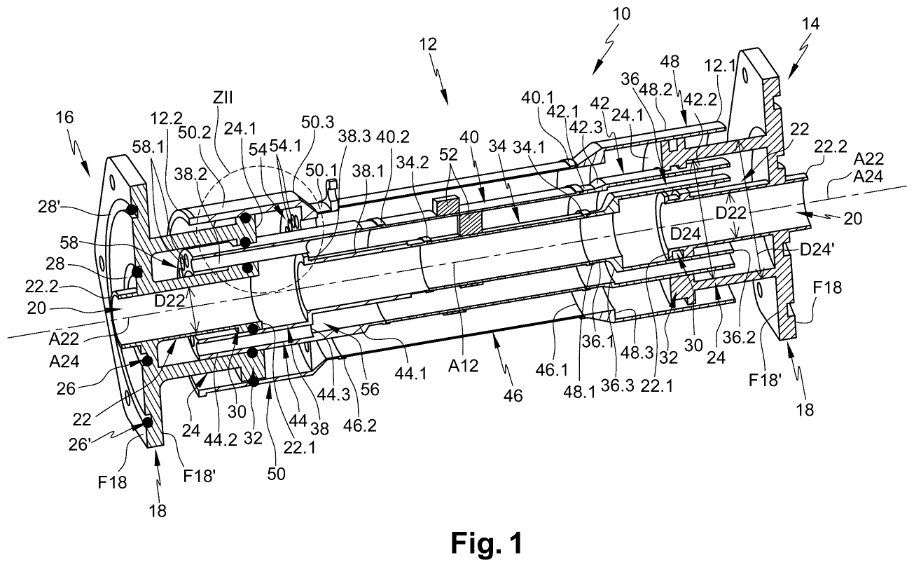

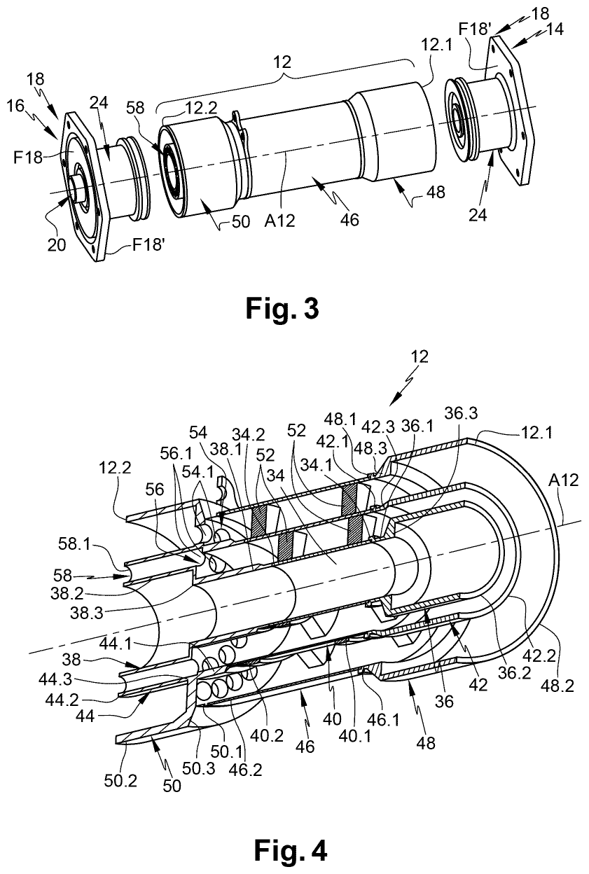

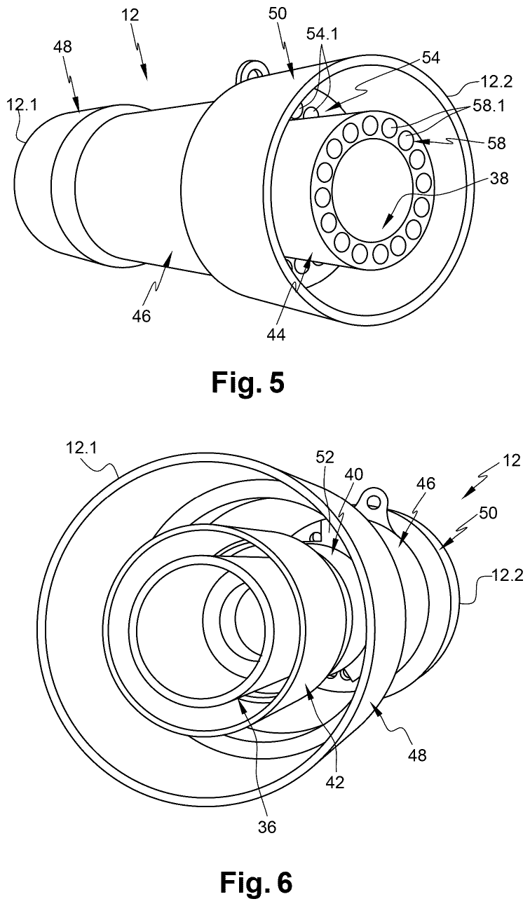

According to an embodiment shown in FIGS. 1 to 6, a triple-walled conduit 10 comprises a main section 12, which has an axis of revolution A12 and extends between first and second ends 12.1, 12.2 and first and second connectors 14, 16, which interact with the first and second ends 12.1, 12.2, respectively, of the main section 12. The main section 12 is thus arranged between the first and second connectors 14, 16.

According to one application, an aircraft comprises at least one hydrogen supply system having at least one triple-walled conduit for channeling hydrogen.

For the remainder of the description, a longitudinal direction is parallel to the axis of revolution A12.

The first and second connectors 14, 16 are substantially identical.

Each of the first and second connectors 14, 16 comprises:
a mounting plate 18, which has a first surface F18 also referred to as bearing surface, a second surface F18′ opposite the first surface F18 and oriented toward the main section 12 and a through-hole 20, which opens out at the first and second surfaces F18, F18′,
a first joining tube 22, which is coaxial with the through-orifice 20, positioned around the latter and projects at least with respect to the second surface F18′ toward the main section 12,
a second joining tube 24, which is coaxial with the first joining tube 22, positioned around the latter and projects at least with respect to the second surface F18′ toward the main section 12.

Each of the first and second connectors 14, 16 comprises at least one seal 26, 26′ (shown in FIG. 1 only for the second connector 16), preferably two concentric seals 26, 26′, situated at the first surface F18. For each seal 26, 26′, each of the first and second connectors 14, 16 has a groove 28, 28′ (shown in FIG. 1 only for the second connector 16) that is recessed with respect to the first surface F18, substantially coaxial with the through-orifice 20 and configured to partially house a seal 26, 26′. These seals 26, 26′ have a function of providing sealing between the first or second connector 14, 16 and an external device (not shown in the figures) to which the triple-walled conduit 10 is intended to be attached.

Each of the first and second joining tubes 22, 24 has an axis of revolution A22, A24 substantially perpendicular to the first surface F18. The axes of revolution A22, A24 coincide, the first and second joining tubes 22, 24 being coaxial. The axes of revolution A22, A24 coincide with the axis of revolution A12 of the main section 12 when the triple-walled conduit 10 is assembled.

According to a configuration shown in FIG. 1, the first joining tube 22 extends on either side of the mounting plate 18 and has a first end 22.1 that projects with respect to the second surface F18′ and a second end 22.2 that projects with respect to the first surface F18. According to another configuration, which is not shown in the figures, the first joining tube 22 may extend only toward the main section 12 and may not project with respect to the first surface F18.

The second tube 24 has a first end 24.1, which is remote from the mounting plate 18, the second end of the second tube 24 being connected to and coincident with the mounting plate 18.

According to one embodiment, the first and second joining tubes 22, 24 have substantially identical lengths (distances separating, for each of them, the first end 22.1, 24.1 from the mounting plate 18). Of course, one of the first and second joining tubes 22, 24 could be longer or shorter than the other of the first and second joining tubes 22, 24.

Each of the first and second joining tubes 22, 24 comprises, at its first end 22.1, 24.1, a first or second head 30, 32 configured to interact in a sealed manner with the main section 12.

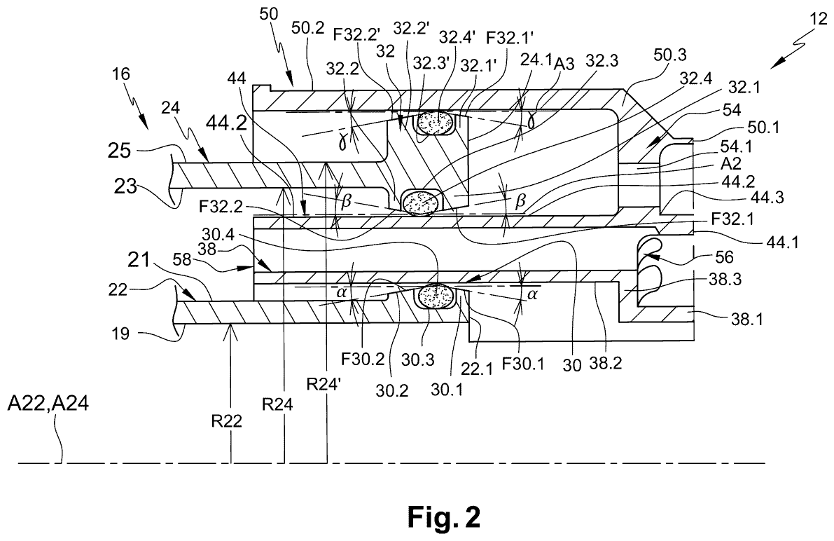

As illustrated in FIG. 2, the first joining tube 22 comprises a substantially cylindrical internal surface 19, which has a diameter D22 (shown in FIG. 1) or a radius R22 (shown in FIG. 2) substantially equal to that of the through-orifice 20, and a substantially cylindrical external surface 21 outside the first head 30. At the first head 30, the first joining tube 22 comprises two peripheral protrusions 30.1, 30.2 that project with respect to the external surface 21 and are spaced apart (longitudinally along the axis of revolution A22) so as to delimit an annular groove 30.3, which is configured to at least partially house an O-ring 30.4, between them. The first end 22.1, the two peripheral protrusions 30.1, 30.2 and the annular groove 30.3 form the first head 30 of the first joining tube 22. According to one arrangement, each peripheral protrusion 30.1, 30.2 comprises a frustoconical or curved peripheral face F30.1, F30.2 (the face of the peripheral protrusion 30.1, 30.2 furthest from the external surface 21 with respect to the axis of revolution A22), the diameter of the peripheral face F30.1, F30.2 decreasing in a direction away from the annular groove 30.3. More precisely, the peripheral face F30.1, F30.2 extends at an angle α with respect to an axis A1 parallel to the axis of revolution A22 (the angle α being radially located below the axis A1 with respect to the axis of revolution A22), the angle α being between 0.5° and 5°, preferably around 2°, in order to preserve degrees of freedom in rotation of the connector 14, 16 with respect to the main section 12, and therefore in the triple-walled conduit 10.

The second joining tube 24 comprises a substantially cylindrical internal surface 23, outside the second head 32, which has an internal diameter D24 (shown in FIG. 1) or an internal radius R24 (shown in FIG. 2) and a substantially cylindrical external surface 25, outside the second head 32, which has an external diameter D24′ (shown in FIG. 1) or an external radius R24′ (shown in FIG. 2). At the second head 32, the second joining tube 24 comprises:
at its internal surface 23, two internal peripheral protrusions 32.1, 32.2 that project with respect to the internal surface 23 and are spaced apart (longitudinally along the axis of revolution A24) so as to delimit an internal annular groove 32.3, which is configured to at least partially house an internal O-ring 32.4, between them and,
at its external surface 25, two external peripheral protrusions 32.1′, 32.2′ that project with respect to the external surface 25 and are spaced apart (longitudinally along the axis of revolution A24) so as to delimit an external annular groove 32.3′, which is configured to at least partially house an external O-ring 32.4′, between them.

The first end 24.1 of the second conduit 24, the internal and external peripheral protrusions 32.1, 32.2, 32.1′, 32.2′ and the internal and external annular grooves 32.3, 32.3′ form the second head 32 of the second joining tube 24.

According to one arrangement, each internal peripheral protrusion 32.1, 32.2 comprises a frustoconical or curved peripheral face F32.1, F32.2 (the face of the internal peripheral protrusion 32.1, 32.2 closest to the axis of revolution A24), the diameter of the peripheral face F32.1, F32.2 increasing in a direction away from the internal annular groove 32.3. More precisely, the internal peripheral face 32.1, 32.2 extends at an angle β with respect to an axis A2 parallel to the axis of revolution A24 (the angle β being radially located above the axis A2 with respect to the axis of revolution A24), the angle β being between 0.5° and 5°, preferably around 2°, in order to preserve degrees of freedom in rotation of the connector 14, 16 with respect to the main section 12, and therefore in the triple-walled conduit 10. In addition, each external peripheral protrusion 32.1′, 32.2′ comprises a frustoconical or curved peripheral face F32.1′, F32.2′ (the face of the external peripheral protrusion 32.1′, 32.2′ furthest from the external surface 25 with respect to the axis of revolution A24), the diameter of the peripheral face F32.1′, F32.2′ decreasing in a direction away from the external annular groove 32.3. More precisely, the external peripheral face 32.1′, 32.2′ extends at an angle γ with respect to an axis A3 parallel to the axis of revolution A24 (the angle γ being radially located below the axis A3 with respect to the axis of revolution A24), the angle γ being between 0.5° and 5°, preferably around 2°, in order to preserve degrees of freedom in rotation of the connector 14, 16 with respect to the main section 12, and therefore in the triple-walled conduit 10. This arrangement makes it possible to obtain a connection that allows slight angular displacement between the first or second connector 14, 16 and the main section 12.

According to one embodiment, each of the first and second connectors 14, 16 is metallic and obtained by machining. Of course, the invention is not limited to this material and to this manufacturing technique.

As shown in FIG. 1, the main section 12 comprises an internal tube 34, which extends between first and second ends 34.1, 34.2 and is extended by a first internal endpiece 36 integral with the first end 34.1 and by a second internal endpiece 38 integral with the second end 34.2, an intermediate tube 40, which extends between first and second ends 40.1, 40.2 and is extended by a first intermediate endpiece 42 integral with the first end 40.1 and by a second intermediate endpiece 44 integral with the second end 40.2, and an external tube 46, which extends between first and second ends 46.1, 46.2 and is extended by a first external endpiece 48 integral with the first end 46.1 and by a second external endpiece 50 integral with the second end 46.2.

The internal, intermediate and external tubes 34, 40, 46 are substantially coaxial. The internal tube 34 is arranged in the intermediate tube 40, which is itself arranged in the external tube 46. In other words, the external tube 46 is arranged around the intermediate tube 40, which is itself arranged around the internal tube 34. The main section 12 comprises spacers 52 for keeping the internal, intermediate and external tubes 34, 40, 46 spaced apart. The number and the positioning of the spacers 52 are determined on the basis of the length of the internal, intermediate and external tubes 34, 40, 46.

The internal tube 34 has an inner diameter substantially identical to that of the first joining tube 22.

The internal, intermediate and external tubes 34, 40, 46 can be metallic or made of composite material.

According to one embodiment, the first internal, intermediate and external endpieces 36, 42, 48 are distinct and substantially coaxial.

Each of the first internal, intermediate and external endpieces 36, 42, 48 comprises:
a first tubular portion 36.1, 42.1, 48.1 connected in a sealed manner to the first end 34.1, 40.1, 46.1 of the corresponding internal, intermediate or external tube 34, 40, 46,
a second tubular portion 36.2, 42.2, 48.2, which interacts with the first or second head 30, 32 of the first or second joining tube 22, 24 of a first connector 14 and has an inner diameter that is larger than that of the first tubular portion 36.1, 42.1, 48.1,
a generally frustoconical intermediate portion 36.3, 42.3, 48.3 connecting the first and second tubular portions 36.1, 36.2, 42.1, 42.2, 48.1, 48.2.

According to one configuration, the first head 30 of the first joining tube 22 of the first connector 14 is positioned inside the second tubular portion 36.2 of the first internal endpiece 36. In addition, the second head 32 of the second joining tube 24 of the same first connector 14 is interposed between the second tubular portions 42.2, 48.2 of the first intermediate and external endpieces 42, 48. To this end, the second tubular portion 36.2 of the first internal endpiece 36 has an inner surface designed to allow the O-ring 30.4, supported by the first head 30, to slide in the longitudinal direction with respect to said inner surface while being compressed between the second tubular portion 36.2 of the first internal endpiece 36 and the first head 30. The second tubular portion 42.2 of the first intermediate endpiece 42 has an outer surface designed to allow the internal O-ring 32.4, supported by the second head 32, to slide in the longitudinal direction with respect to said outer surface while being compressed between the second tubular portion 42.2 of the first intermediate endpiece 42 and the second head 32. The second tubular portion 48.2 of the first external endpiece 48 has an inner surface designed to allow the external O-ring 32.4′, supported by the second head 32, to slide in the longitudinal direction with respect to said inner surface while being compressed between the second tubular portion 48.2 of the first external endpiece 48 and the second head 32.

According to one embodiment, the second internal, intermediate and external endpieces 38, 44, 50 are substantially coaxial and connected together so as to form a one-piece component.

Each of the second internal, intermediate and external endpieces 38, 44, 50 comprises:
a first tubular portion 38.1, 44.1, 50.1 connected in a sealed manner to the second end 34.2, 40.2, 46.2 of the corresponding internal, intermediate or external tube 34, 40, 46,
a second tubular portion 38.2, 44.2, 50.2, which interacts with the first or second head 30, 32 of the first or second joining tube 22, 24 of a second connector 16 and has an inner diameter that is larger than that of the first tubular portion 38.1, 44.1, 50.1,
a generally frustoconical intermediate portion 38.3, 44.3, 50.3 connecting the first and second tubular portions 38.1, 38.2, 44.1, 44.2, 50.1, 50.2.

According to a configuration shown in FIG. 2, the first head 30 of the first joining tube 22 of the second connector 16 is positioned inside the second tubular portion 38.2 of the second internal endpiece 38. In addition, the second head 32 of the second joining tube 24 of the same second connector 16 is interposed between the second tubular portions 44.2, 50.2 of the second intermediate and external endpieces 44, 50. To this end, the second tubular portion 38.2 of the second internal endpiece 38 has an inner surface designed to allow the O-ring 30.4, supported by the first head 30, to slide in the longitudinal direction with respect to said inner surface while being compressed between the second tubular portion 38.2 of the second internal endpiece 38 and the first head 30. The second tubular portion 44.2 of the second intermediate endpiece 44 has an outer surface designed to allow the internal O-ring 32.4, supported by the second head 32, to slide in the longitudinal direction with respect to said outer surface while being compressed between the second tubular portion 44.2 of the second intermediate endpiece 44 and the second head 32. The second tubular portion 50.2 of the second external endpiece 50 has an inner surface designed to allow the external O-ring 32.4′, supported by the second head 32, to slide in the longitudinal direction with respect to said inner surface while being compressed between the second tubular portion 50.2 of the second external endpiece 50 and the second head 32.

According to one embodiment, the main section 12 comprises at least one annular first joining wall 54, which connects the intermediate and external endpieces 44, 50 and has an inner edge connected to the intermediate endpiece 44 and an outer edge connected to the external endpiece 50. According to one arrangement, the first joining wall 54 is positioned in a transverse plane (substantially perpendicular to the longitudinal direction). The first joining wall 54 is positioned in line with the intermediate portions 44.3, 50.3 of the intermediate and external endpieces 44, 50. The first joining wall 54 comprises at least one through-orifice 54.1 that makes it possible to place first and second regions situated on either side of the first joining wall 54 in communication. According to one configuration, the first joining wall 54 comprises a plurality of through-orifices 54.1 distributed regularly over the entire circumference of the first joining wall 54.

The main section 12 comprises at least one second joining wall 56, which connects the internal and intermediate endpieces 38, 44 and has an inner edge connected to the internal endpiece 38 and an outer edge connected to the intermediate endpiece 44. According to one arrangement, the second joining wall 56 is positioned in a transverse plane (substantially perpendicular to the longitudinal direction).

According to one embodiment, the main section 12 comprises second and third joining walls 56, 58, which connect the internal and intermediate endpieces 38, 44 and are spaced apart from one another in the longitudinal direction, the second joining wall 56 being positioned in line with the intermediate portions 38.3, 44.3 of the internal and intermediate endpieces 38, 44, the third joining wall 58 being positioned in line with the free ends of the second tubular portions 38.2, 44.2 of the internal and intermediate endpieces 38, 44.

As shown in FIG. 4 in particular, each of the second and third joining walls 56, 58 comprises at least one through-orifice 56.1, 58.1 that makes it possible to place first and second regions situated on either side of the second or third joining wall 56, 58 in communication. According to one configuration, the second or third joining wall 56, 58 comprises a plurality of through-orifices 56.1, 58.1 distributed regularly over the entire circumference of the second or third joining wall 56, 58.

According to one embodiment, the first and second internal, external and intermediate endpieces are metallic.

According to another embodiment, the first and second internal, external and intermediate endpieces are made of a composite material or of a thermoplastic material (i.e., of an electrically insulating material), for example of PEEK (polyether ether ketone). This advantageously makes it possible to have an electrically non-conductive, i.e., electrically insulating, main section 12.

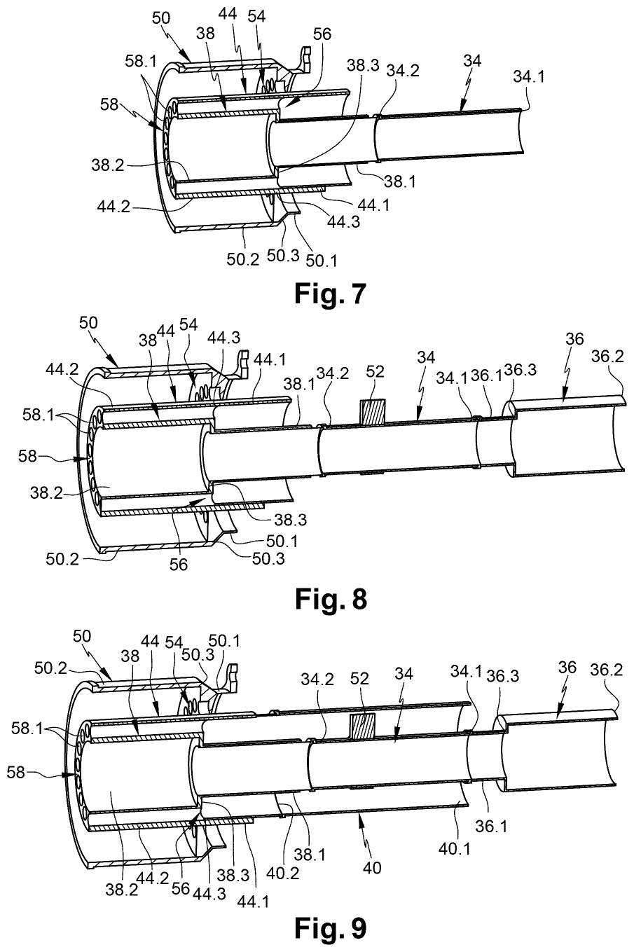

A method for assembling the main section 12 is described with reference to FIGS. 7 to 12.

In a first step, with the internal tube 34 and the second internal, intermediate and external endpieces 38, 44, 50 being made of metallic material, the component that groups together the second internal, intermediate and external endpieces 38, 44, 50 is connected to the internal tube 34 by welding the second end 34.2 of the internal tube 34 to the first tubular portion 38.1 of the second internal endpiece 38, as illustrated in FIG. 7. In a variant, in a first step, with the internal tube 34 and the second internal, intermediate and external endpieces 38, 44, 50 being made of non-metallic material, for example of composite material, the component that groups together the second internal, intermediate and external endpieces 38, 44, 50 is connected to the internal tube 34 by adhesively bonding the second end 34.2 of the internal tube 34 to the first tubular portion 38.1 of the second internal endpiece 38 (or by any other known joining means capable of joining two composite elements).

Next, at least one spacer 52 is positioned around the internal tube 34 and the first end 34.1 of the internal tube 34 is welded to the first tubular portion 36.1 of the first internal endpiece 36, as illustrated in FIG. 8.

The intermediate tube 40 is positioned around the internal tube 34 and its second end 40.2 is welded to the first tubular portion 44.1 of the second intermediate endpiece 44, as illustrated in FIG. 9.

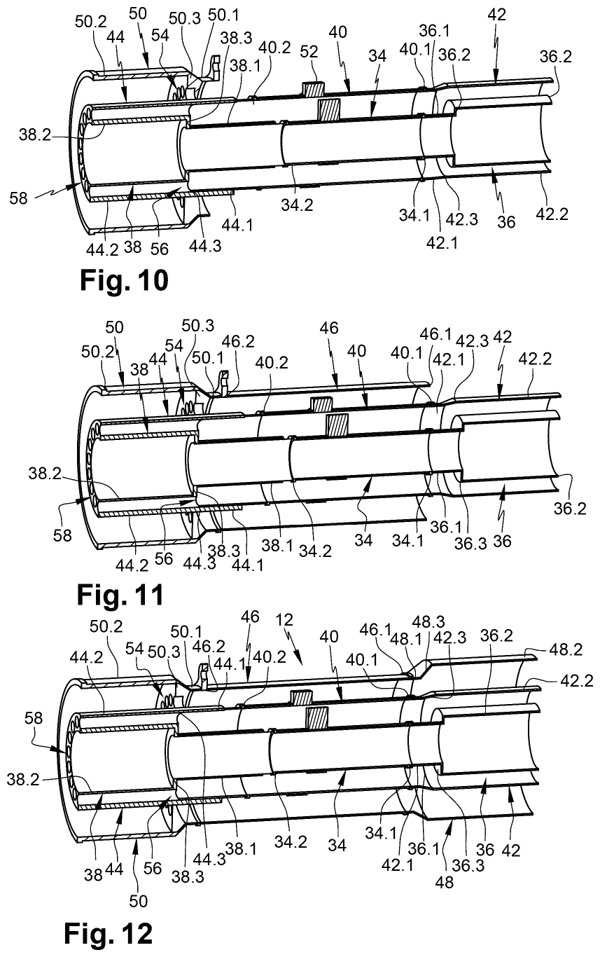

Next, at least one spacer 52 is positioned around the intermediate tube 40 and the first end 40.1 of the intermediate tube 40 is welded to the first tubular portion 42.1 of the first intermediate endpiece 42, as illustrated in FIG. 10.

The external tube 46 is positioned around the intermediate tube 40 and its second end 46.2 is welded to the first tubular portion 50.1 of the second external endpiece 50, as illustrated in FIG. 11.

Finally, the first end 46.1 of the external tube 46 is welded to the first tubular portion 48.1 of the first external endpiece 48, as illustrated in FIG. 12.

Of course, the invention is not limited to this embodiment for the main section 12.

Moreover, the triple-walled conduit could comprise just one connector 14 interacting with a main section. Furthermore, each of the seals 30.4, 32.4, 32.4′ could be replaced by any other sealing system.

Thus, the triple-walled conduit comprises at least:
a main section 12 that has:
an internal tube 34 extended by at least one first internal endpiece 36 having inner and outer surfaces,
an intermediate tube 40 extended by at least one first intermediate endpiece 42 having inner and outer surfaces,
an external tube 46 extended by at least one first external endpiece 48 having inner and outer surfaces,
at least one connector 14 that has a through-hole 20 and joining tubes 22, 24, which surround the through-hole 20 and are positioned inside one another, each of the joining tubes 22, 24 having a portion that faces at least one inner or outer surface of the first internal, intermediate and external endpieces 36, 42, 48 of the main section 12,
at least one first sealing system interposed between the inner or outer surface of the first internal endpiece 36 and one of the joining tubes of the connector 14,
at least one second sealing system interposed between the inner or outer surface of the first intermediate endpiece 42 and one of the joining tubes of the connector 14,
at least one third sealing system interposed between the inner or outer surface of the first external endpiece 48 and one of the joining tubes of the connector 14.

This solution makes it possible to obtain three sealing systems in series between the inside of the internal tube 34 and the outside of the external tube 46, thereby contributing to enhancing the safety compared to a double-walled conduit.

According to one embodiment, the connector 14 comprises first, second and third joining tubes, the first sealing system being interposed between the inner or outer surface of the first internal endpiece 36 and the first joining tube, the second sealing system being interposed between the inner or outer surface of the first intermediate endpiece 42 and the second joining tube, the third sealing system being interposed between the inner or outer surface of the first external endpiece 48 and the third joining tube.

According to a preferred solution that makes it possible in particular to reduce the mass of the connector 14 and to simplify it, the latter comprises solely first and second joining tubes 22, 24, at least one of which is positioned between the first internal and intermediate endpieces 36, 42 or between the first intermediate and external endpieces 42, 48.

According to one solution, the first joining tube 22 is positioned inside the first internal endpiece 36 or the second joining tube 24 is positioned outside the first external endpiece 48. Thus, at least one region situated between the first internal and intermediate endpieces 36, 42 or between the first intermediate and external endpieces 42, 48 does not comprise a joining tube, thereby making it possible to reduce its thickness (dimension measured in a direction perpendicular to the axis of revolution A12). This solution makes it possible to obtain a more compact triple-walled conduit. As illustrated in FIG. 1, the first joining tube 22 is positioned inside the first internal endpiece 36 and the second joining tube 24 is positioned between the first intermediate and external endpieces 42, 48.

According to one configuration, the main section 12 comprises at least two joining walls 54, 56, 58 connecting the internal, intermediate and external tubes 34, 40, 46 and/or the first or second internal, intermediate and external endpieces 36, 38, 42, 44, 48, 50 in pairs. This solution makes it possible to keep the internal tube 34 and its first and second internal endpieces 36, 38 spaced apart from the intermediate tube 40 and from its first and second intermediate endpieces 42, 44, respectively, the latter being spaced apart from the external tube 46 and from its first and second external endpieces 48, 50.

Each joining wall 54, 56, 58 is recessed and/or perforated and/or comprises through-orifices 54.1, 56.1, 58.1 in order to reduce the mass of the triple-walled conduit.

According to one preferred solution, each sealing system comprises two peripheral protrusions 30.1, 32.1, 32.1′, 30.2, 32.2, 32.2′ that are spaced apart so as to delimit an annular groove 30.3, 32.3, 32.3′ between them and an O-ring 30.4, 32.4, 32.4′, which is at least partially housed in the annular groove 30.3, 32.3, 32.3′ and compressed between the main section 12 and one of the connectors 14, 16. According to one configuration, the two peripheral protrusions are integral with a joining tube 22, 24. In a variant, they could be integral with one of the internal, intermediate or external endpieces.

In order to allow slight angular displacement between the main section 12 and each connector 14, 16, each peripheral protrusion 30.1, 32.1, 32.1′, 30.2, 32.2, 32.2′ comprises a frustoconical or curved peripheral face F30.1, F32.1, F32.1′, F30.2, F32.2, F32.2′, the diameter of the peripheral face F30.1, F32.1, F32.1′, F30.2, F32.2, F32.2′ decreasing or increasing in a direction away from the annular groove 30.3, 32.3, 32.3′, the diameter decreasing if the peripheral protrusions are positioned on the outer surface of the first or second joining tube 22, 24 or of the first internal, intermediate or external endpiece 36, 42, 48, the diameter increasing if the peripheral protrusions are positioned on the inner surface of the first or second joining tube 22, 24 or of the first internal, intermediate or external endpiece 36, 42, 48.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A triple-walled conduit comprising:
a main section that includes
an internal tube extended by at least one first internal endpiece having inner and outer surfaces,
an intermediate tube extended by at least one first intermediate endpiece having inner and outer surfaces,
an external tube extended by at least one first external endpiece having inner and outer surfaces;
at least one connector that has a through-hole and first and second joining tubes, which surround the through-hole and are positioned one inside the other, each of the first and second joining tubes having a portion that faces at least one inner or outer surface of the first internal, intermediate, and external endpieces of the main section;
at least one first sealing system interposed between the inner or outer surface of the at least one first internal endpiece and one of the first and second joining tubes of the at least one connector,
at least one second sealing system interposed between the inner or outer surface of the at least one first intermediate endpiece and one of the first and second joining tubes of the at least one connector; and,
at least one third sealing system interposed between the inner or outer surface of the at least one first external endpiece and one of the first and second joining tubes of the at least one connector.

2. The triple-walled conduit as claimed in claim 1, wherein the first joining tube is positioned inside the at least one first internal endpiece or the second joining tube is positioned outside the at least one first external endpiece.

3. The triple-walled conduit as claimed in claim 2, wherein the first joining tube is positioned inside the at least one first internal endpiece and the second joining tube is positioned between the at least one first intermediate endpiece and the at least one external endpiece.

4. The triple-walled conduit as claimed in claim 1, wherein the main section comprises first and second internal endpieces extending the internal tube on either side, first and second intermediate endpieces extending the intermediate tube on either side, and first and second external endpieces extending the external tube on either side, and
wherein the triple-walled conduit further comprises a first connector interacting with the first internal, intermediate, and external endpieces of the main section and a second connector interacting with the second internal, intermediate, and external endpieces of the main section.

5. The triple-walled conduit as claimed in claim 1, wherein the main section comprises at least two joining walls connecting the internal, intermediate, and external tubes in pairs, or the at least one internal endpiece, the at least one intermediate endpiece, and the at least one external endpiece in pairs, or both.

6. The triple-walled conduit as claimed in claim 5, wherein the at least two joining walls comprises
at least one first joining wall, which connects the at least one intermediate endpiece and the at least one external endpiece and has an inner edge connected to the at least one intermediate endpiece and an outer edge connected to the at least one external endpiece, and
at least one second joining wall, which connects the at least one internal endpiece and the at least one intermediate endpiece and has an inner edge connected to the at least one internal endpiece and an outer edge connected to the at least one intermediate endpiece.

7. The triple-walled conduit as claimed in claim 6, wherein the at least one second joining wall comprises second and third joining walls, which connect the at least one internal endpiece and the at least one intermediate endpiece and are spaced apart from one another.

8. The triple-walled conduit as claimed in claim 1, wherein each sealing system comprises
two peripheral protrusions that are spaced apart so as to delimit an annular groove between them and
an O-ring, which is at least partially housed in the annular groove and compressed between the main section and the at least one connector.

9. The triple-walled conduit as claimed in claim 8, wherein the two peripheral protrusions are integral with a joining tube of a connector.

10. The triple-walled conduit as claimed in either of claims 8, wherein each peripheral protrusion comprises a frustoconical or curved peripheral face, a diameter of the frustoconical or curved peripheral face decreasing or increasing in a direction away from the annular groove in order to allow angular displacement between the main section and the connector.

11. An aircraft comprising:
at least one triple-walled conduit as claimed in claim 1.
